(19) United States
(12) Patent Application Publication
(10) Pub. No.: US 2014/0192164 A1
(43) Pub. Date: Jul. 10, 2014

(54) SYSTEM AND METHOD FOR DETERMINING DEPTH INFORMATION IN AUGMENTED REALITY SCENE

(71) Applicant: INDUSTRIAL TECHNOLOGY RESEARCH INSTITUTE, Hsinchu (TW)

(72) Inventors: Hian-Kun TENN, Kaohsiung City (TW); Yao-Yang TSAI, Kaohsiung (TW); Ko-Shyang WANG, Kaohsiung City (TW); Po-Lung CHEN, Taipei City (TW)

(73) Assignee: INDUSTRIAL TECHNOLOGY RESEARCH INSTITUTE, Hsinchu (TW)

(21) Appl. No.: 13/735,838

(22) Filed: Jan. 7, 2013

(51) Int. Cl. H04N 13/02

(52) U.S. Cl. CPC H04N 13/0239
USPC 348/47

(57) ABSTRACT

A system and method for determining individualized depth information in an augmented reality scene are described. The method includes receiving a plurality of images of a physical area from a plurality of cameras, extracting a plurality of depth maps from the plurality of images, generating an integrated depth map from the plurality of depth maps, and determining individualized depth information corresponding to a point of view of the user based on the integrated depth map and a plurality of position parameters.

### TECHNICAL FIELD

This disclosure relates to system and method of determining depth information in an augmented reality scene.

### BACKGROUND

Augmented reality (AR) has become more common and popular in different applications, such as medicine, healthcare, entertainment, design, manufacturing, etc. One of the challenges in AR is to integrate virtual objects and real objects into one AR scene and correctly render their relationships so that users have a high fidelity immersed experience.

Conventional AR applications often directly overlay the virtual objects on top of the real ones. This may be suitable for basic applications such as interactive card games. For more sophisticated applications, however, conventional AR applications may introduce a conflicting user experience, causing user confusion. For example, if a virtual object is expected to be occluded by a real object, then overlaying the virtual object on the real one results in improper visual effects, which reduce fidelity of the AR rendering.

Furthermore, for multiple-user applications, conventional AR systems usually provide visual feedback from a single point of view (POV). As a result, conventional AR systems are incapable of providing a first-person point of view to individual users, further diminishing the fidelity of the rendering and the immersed experience of the users.

### SUMMARY

According to an embodiment of the present disclosure, there is provided a method for determining individualized depth information in an augmented reality scene. The method comprises receiving a plurality of images of a physical area from a plurality of cameras; extracting a plurality of depth maps from the plurality of images; generating an integrated depth map from the plurality of depth maps; and determining individualized depth information corresponding to a point of view of a user based on the integrated depth map and a plurality of position parameters.

According to another embodiment of the present disclosure, there is provided a non-transitory computer-readable medium. The computer-readable medium comprises instructions, which, when executed by a processor, causes the processor to perform a method for determining individualized depth information in an augmented reality scene. The method comprises receiving a plurality of images of a physical area from a plurality of cameras; extracting a plurality of depth maps from the plurality of images; generating an integrated depth map from the plurality of depth maps; and determining individualized depth information corresponding to a point of view of a user based on the integrated depth map and a plurality of position parameters.

According to another embodiment of the present disclosure, there is provided a system for determining individualized depth information in an augmented reality scene. The system comprises a memory for storing instructions. The system further comprises a processor for executing the instructions to receive a plurality of images of a physical area from a plurality of cameras; extract a plurality of depth maps from the plurality of images; generate an integrated depth map from the plurality of depth maps; receive position parameters from a user device, the position parameters indicative of a point of view of a user associated with the user device within the physical area; and determine individualized depth information corresponding to the point of view of the user based on the integrated depth map and the position parameters.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the present disclosure and, together with the description, serve to explain the principles of the invention.

FIG. 1 depicts a schematic diagram of a system for generating images of an augmented reality (AR) scene according to an embodiment;

FIG. 2 depicts an exemplary AR scene implemented on the system of FIG. 1 including real and virtual objects;

FIG. 3 depicts a process for generating images of an AR scene using the system of FIG. 1 according to an embodiment;

FIG. 4 depicts an image acquisition process for calibration;

FIG. 5 depicts a calibration process using images acquired in FIG. 4; and

FIGS. 6A-6D depict images generated during the calibration process of FIG. 5.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of systems and methods consistent with aspects related to the invention as recited in the appended claims.

In general, the present disclosure describes a system and method for generating real-time images of an augmented reality (AR) scene for multiple users corresponding to and consistent with their individual point of view (POV). In one embodiment, the system includes a plurality of cameras arranged in a working area for capturing depth maps of a working area, from different points of view. The system then uses the captured depth maps to generate an integrated depth map of the working area and uses the integrated depth map for rendering images of virtual and real objects within the AR scene. The cameras are connected to a server which is configured to process the incoming depth maps from the cameras and generate the integrated depth map.

Further, the system includes a plurality of user devices. Each user device includes an imaging apparatus to acquire images of the working area and a display apparatus to provide visual feedback to a user associated with the user device. The user devices communicate with the server described above. For example, each user device detects and sends its own spatial or motion parameters (e.g., translations and orientations) to the server and receives computation results from the server.

Based on the integrated depth map and the spatial parameters from the user devices, the server generates depth information for the individual users corresponding to and consistent with their first-person points of view. The user devices receive the first-person POV depth information from the server and then utilize the first-person POV depth information to render individualized images of the AR scene consistent with the points of view of the respective users. The individualized image of the AR scene is a combination of images of the real objects and images of the virtual objects. In generating the images of the AR scene, the user devices determine spatial relationships between the real and virtual objects based on the first-person POV depth information for the individual users and render the images accordingly.

Alternatively, the server receives images of real objects captured by individual user devices and renders the images of the AR scene for the individual user devices consistent with the points of view of the respective users. The server then transmits the rendering results to the corresponding user devices for display to their users. Similarly, in generating the images of the AR scene, the server determines spatial relationships between the real and virtual objects based on the first-person POV depth information for a particular user and renders the image consistent with the first-person POV of the particular user.

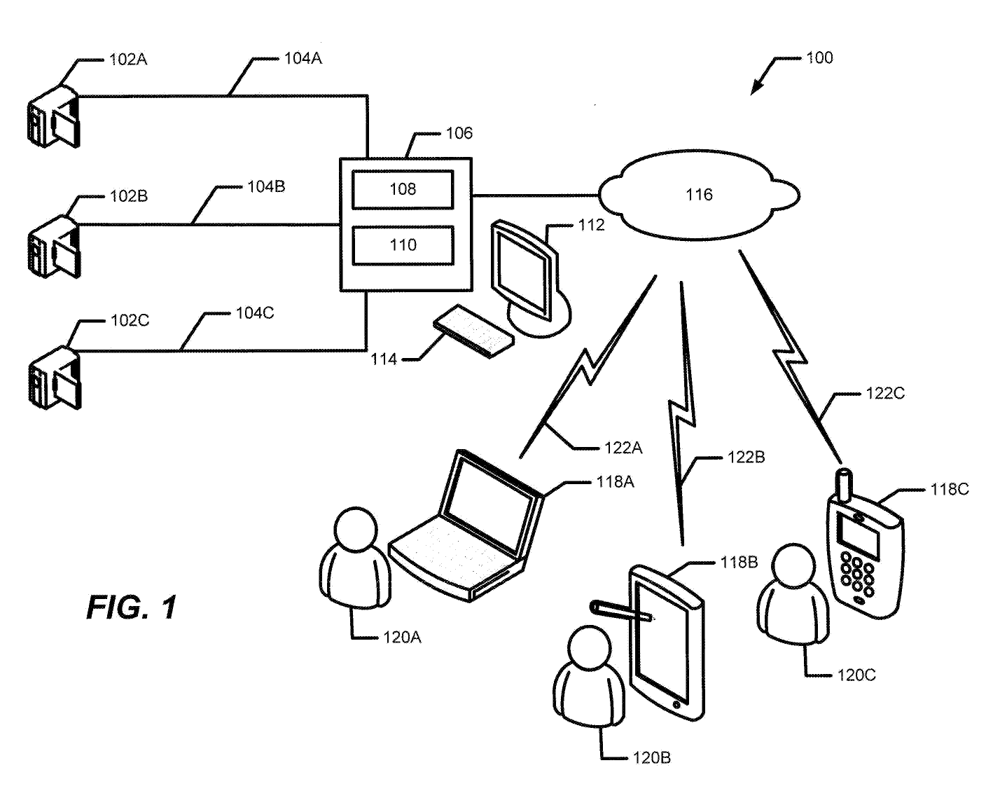

FIG. 1 illustrates a schematic diagram of a system 100 for rendering images of an augmented reality (AR) scene. System 100 includes a plurality of cameras 102A-102C configured to generate data including, for example, images of real objects within a working area. The term “working area” refers to a physical area or space, based on which an AR scene is rendered. The real objects in the working area may include any physical objects, such as human, animals, buildings, vehicles, and any other objects or things that may be represented in the images generated by cameras 102A-102C.

According to the present disclosure, the data generated by one of cameras 102A-102C includes a depth map of the real objects in the working area as viewed through that particular camera. The data points in the depth map represent relative spatial relationships among the real objects within the working area. For example, each data point in the depth map indicates a distance between a real object and a reference within the working area. The reference may be, for example, an optical center of the corresponding camera or any other physical reference defined within the working area.

Cameras 102A-102C are further configured to transmit the data through communication channels 104A-104C, respectively. Communication channels 104A-104C provide wired or wireless communications between cameras 102A-102C and other system components. For example, communication channels 104A-104C may be part of the Internet, a Local Area Network (LAN), a Wide Area Network (WAN), a wireless LAN, etc., and may be based on techniques such as Wi-Fi, Bluetooth, etc.

System 100 further includes a server 106 including a computer-readable medium 108, such as a RAM, a ROM, a CD, a flash drive, a hard drive, etc., for storing data and computer-executable instructions related to the processes described herein. Server 106 also includes a processor 110, such as a central processing unit (CPU), known in the art, for executing the instructions stored in computer-readable medium 108. Server 106 is further coupled to a display device 112 and a user input device 114. Display device 112 is configured to display information, images, or videos related to the processes described herein. User input device 114 may be a keyboard, a mouse, a touch pad, etc., and allow an operator to interact with server 106.

Server 106 is further configured to receive the data generated by cameras 102A-102C through respective communication channels 104A-104C and to store the data. Processor 110 then processes the data according to the instructions stored in computer-readable medium 108. For example, processor 110 extracts depth maps from the images provided by cameras 102A-102C and performs coordinate transformations on the depth maps. If the images provided by cameras 102A-102C include depth maps, processor 110 performs coordinate transformations on the images without intermediate steps.

Based on the depth maps generated from individual cameras 102A-102C, processor 110 generates an integrated depth map representing three-dimensional spatial relationships among the real objects within the working area. Each data point in the integrated depth map indicates a distance between a real object and a reference within the working area.

Server 106 is further connected to a network 116 and configured to communicate with other devices through network 116. Network 116 may be the Internet, an Ethernet, a LAN, a WLAN, a WAN, or other networks known in the art.

Additionally, system 100 includes one or more user devices 118A-118C in communication with server 106 through network 116. User devices 118A-118C are associated with individual users 120A-120C, respectively, and may be moved according to the users' motions. User devices 118A-118C communicate with network 116 through communication channels 122A-122C, which may be wireless communication links. For example, communication channels 122A-122C may include Wi-Fi links, Bluetooth links, cellular connections, or other wireless connections known in the art. Additionally or alternatively, communication channels 122A-122C may include wired connections, such as Ethernet links, LAN connections, etc. Whether wired or wireless connections, communication channels 122A-122C allow user devices 118A-118C to be moved as users 120A-120C desire.

According to the present disclosure, user devices 118A-118C are mobile computing devices, such as laptops, PDAs, smart phones, electronic data glasses, head-mounted display devices, etc., and each have an imaging apparatus, such as a digital camera, disposed therein. The digital cameras allow user devices 118A-118C to capture additional images of the real objects in the working area. Each user device 118A-118C also includes a computer readable medium for storing data and instructions related to the processes described herein and a processor for executing the instructions to process the data. For example, the processor processes the additional images captured by the digital camera and renders images of an AR scene including real and virtual objects.

User devices 118A-118C each include a displaying apparatus for displaying the images of the AR scene. According to the present disclosure, user devices 118A-118C display the images of the AR scene in substantially real time. That is, the time interval between capturing the images of the working area by user devices 118A-118C and displaying the images of the AR scene to users 120A-120C is minimized, so that users 120A-120C do not experience any apparent time delay in the visual feedback.

In addition, each one of user devices 118A-118C is further configured to determine position parameters, including, for example, its location, motion, and orientation corresponding to a point of view of the associated user. In one embodiment, each of user devices 118A-118C has a position sensor such as a GPS sensor or other navigational sensor and determines its position parameters through the position sensors. Alternatively, each of user devices 118A-118C may determine its respective position parameters through, for example, dead reckoning, ultrasonic measurements, or radio waves such as Wi-Fi signals, infrared signals, ultra-wide band (UWB) signals, etc. Additionally or alternatively, each of user devices 118A-118C may determine its orientation through measurements from inertial sensors, such as accelerometers, gyros, or electronic compasses, disposed therein.

Additionally or alternatively, according to the present disclosure, each of user devices 118A-118C includes sensible tags attached thereon. A suitable imaging device, such as cameras 102A-102C, is used to capture images of user devices 118A-118C. The imaging device then transmits the images to server 106, which detects the tags associated with user devices 118A-118C and determines the position parameters of user devices 118A-118C based on the images of the respective tags.

According to the present disclosure, user devices 118A-118C transmit their position parameters to server 106. Based on the position parameters and the integrated depth map previously generated, server 106 calculates depth information corresponding to the points of view of respective users 120A-120C. Server 106 then transmits the depth information to the respective user devices 118A-118C. Upon receiving the depth information, each of user devices 118A-118C combines images of the virtual objects with additional images of the working area captured by the imaging apparatus disposed therein and forms images of the AR scene corresponding to the points of view of respective users 120A-120C.

Alternatively, instead of rendering images of the AR scene on individual user devices 118A-118C, user devices 118A-118C can transmit the additional images of the working area to server 106 along with their respective position parameters. Server 106 forms images of the AR scene by combining images of the virtual objects with the additional images of the working area from user devices 118A-118C according to the respective depth information. Server 106 then renders the images of the AR scene for user devices 118A-118C according to their respective depth information and transmits the resulting images to corresponding user devices 118A-118C for display thereon.

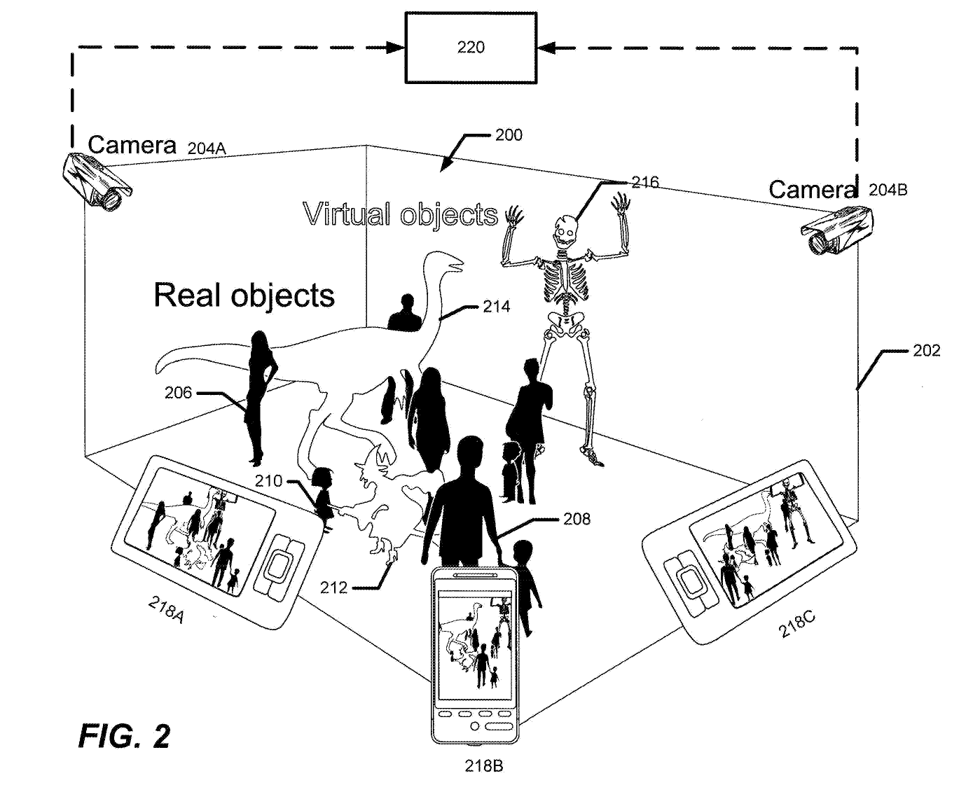

FIG. 2 illustrates an embodiment of an AR scene 200 implemented on system 100 of FIG. 1. AR scene 200 is a virtual exhibition site generated based on a working area 202, including real objects 206, 208, and 210, such as visitors to the exhibition site, and virtual objects 212, 214, and 216, such as items on display at the exhibition site. Virtual objects 212, 214, and 216 are depicted in white silhouette, indicating that they are not physically present within working area 202, but computer generated and only rendered in an image of AR scene 200 as computer-generated virtual objects. Real objects 206, 208, and 210 are depicted in black silhouette, indicating that they are physically present within working area 202.

As further depicted in FIG. 2, a plurality of cameras 204A and 204B, generally corresponding to cameras 102A-102C of FIG. 1, are arranged to capture images of working area 202 and transmit the images to a server 220. Server 220 generally corresponds to server 106 of FIG. 1 and is configured to generate an integrated depth map based on the images received from cameras 204A and 204B.

In addition, one or more user devices 218A-218C, generally corresponding to user devices 118A-118C, are configured to communicate with server 220. User devices 218A-218C also capture additional images of working area 202 and determine and transmit their respective position parameters to server 220.

Based on the integrated depth map and the position parameters of individual user devices 218A-218C, server 220 generates depth information for individual users of user devices 218A-218C corresponding to the points of view of respective users.

According to a further embodiment, user devices 218A-218C transmits the additional images of working area 202 to server 220, and server 220 renders images of AR scene 200 based on the additional images provided by user devices 218A-218C. The images of AR scene 200 generated by server 220 include images of real objects 206, 208, and 210 and virtual objects 212, 214 and 216 and are consistent with the points of view of respective users of user devices 218A-218C. Server 220 then transmits the resulting images to respective user devices 218A-218C for display thereon.

Alternatively, server 220 transmits the depth information for each individual user to the corresponding one of user devices 218A-218C. User devices 218A-218C then generate images of AR scene 200 according to the depth information, which corresponds to and is consistent with the points of view of the individual users. Thus, different users can view the same exhibition space including the real and virtual objects through user devices 218A-218C from their respective points of view and have a realistic first-person experience within the AR scene.

According to the present disclosure, server 220 may update the depth information in substantially real time when the point of view of a user changes due to movements within the working area. Referring to FIG. 2 for example, the users of devices 218A-218C may move around within virtual exhibition site. User devices 218A-218C periodically update and transmit their position parameters to server 220. Alternatively, server 220 may periodically poll new position parameters from user devices 218A-218C. Based on the updated position parameters and the integrated depth map, server 220 detects a change in the points of view of the users associated with user devices 218A-218C and determines updated depth information for user devices 218A-218C corresponding to the change in the points of view. Based on the updated depth information, server 220 or individual user devices 218A-218C then generate updated images of AR scene 200 consistent with the points of view of the individual users.

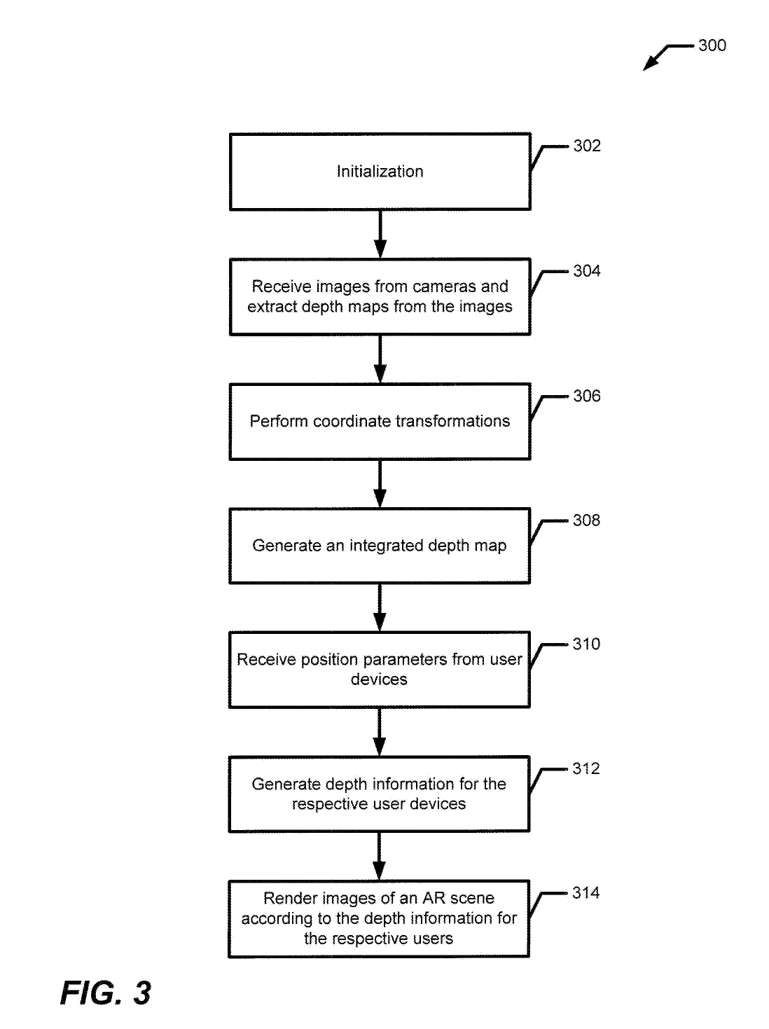

With reference to FIGS. 1-3, a process 300 is described for rendering images of an AR scene according to a first-person point of view of a user. Process 300 may be implemented on, for example, system 100 depicted in FIG. 1. At step 302, the system is initialized. The system checks whether a calibration is required and performs the calibration if necessary.

The calibration process provides one or more transformation matrices ^{j}Ωᵢ representing spatial relationships among cameras 102A-102C. For example, a transformation matrix ^{j}Ωᵢ describes a spatial relationship between camera i and camera j, which correspond to two different ones of cameras 102A-102C. Transformation matrix ^{j}Ωᵢ represents a homogeneous transformation from a coordinate system associated with camera j to that associated with camera i, including a rotational matrix R and a translational vector T, defined as follows:

$${}_{}^{j}{Q}{}_{i}^{} = [ R \vert T ] = [ \begin{matrix}{r}_{11} & {r}_{12} & {r}_{12} & {t}_{1} \\ {r}_{21} & {r}_{22} & {r}_{23} & {t}_{2} \\ {r}_{31} & {r}_{32} & {r}_{33} & {t}_{3} \\ 0 & 0 & 0 & 1\end{matrix} ] , \\ where \text{:}$$

$$R = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ]$$

$$and$$

$$T = [ \begin{matrix}{t}_{1} \\ {t}_{2} \\ {t}_{3}\end{matrix} ] .$$

Elements of the rotational matrix R may be determined based on rotational angles in three orthogonal directions as required for the coordinate transformation from camera j to camera i. Elements of the translational vector T may be determined based on the translations along the three orthogonal directions as required for the coordinate transformation.

In a system having N cameras, a total of N−1 transformation matrices ^{j}Ωᵢ are generated during the calibration process. The calibration process will be further described below.

At step 304, server 106 receives images of the working area from cameras 102A-102C and extracts depth maps from the images. A depth map is a data array, each data element of which indicates a relative position of a real object or a portion thereof with respect to a reference within the working area, when viewed through a respective one of cameras 102A-102C. In working area 202 as shown in FIG. 2, for example, real object 208 is positioned further away from camera 204A than real object 206. Thus, the depth map generated by camera 204A provides a depth value for real object 208 greater than that for real object 206. Accordingly, in the depth map generated from camera 204A, the data elements representing real object 208 have greater values than those representing real object 206.

At step 306, server 106 performs coordinate transformations on the depth maps generated from cameras 102A-102C. The depth maps from different cameras 102A-102C are transformed into a common coordinate system according to the spatial relationships obtained during the calibration process.

Based on transformation matrix ^{j}Ωᵢ between cameras i and j, server 106 transforms a depth map from camera j to the coordinate system associated with camera i. For example, in exemplary system 100 shown in FIG. 1, cameras 102A-102C are designated as camera 1, camera 2, and camera 3, respectively. Server 106 selects, for example, camera 1 (i.e., camera 102A) as a base camera and uses the coordinate system associated with camera 1 as a common coordinate system. Server 106 then transforms the depth maps from all other cameras (e.g., cameras 2 and 3) to the common coordinate system, which is associated camera 1 (i.e., camera 102A). In performing the coordinate transformations, server 106 uses corresponding transformation matrices ¹Ω₂ and ¹Ω₃ to transform depth maps from camera 2 (i.e., camera 102B) and camera 3 (i.e., camera 102C) into the common coordinate system associated with camera 1 (i.e., camera 102A), using the following formulas:

¹D₂=D₂·¹Ω₂, and

¹D₃=D₃·¹Ω₃,

where D₂ and D₃ represent the depth maps from camera 2 and camera 3, respectively, and ¹D₂ and ¹D₃ represent corresponding depth maps after the transformations to the common coordinate system.

At step 308, all the transformed depth maps (e.g., ¹D₂ and ¹D₃) are combined with the depth map (e.g., D₁) of camera 1 into an integrated depth map D, which forms a three-dimensional representation of depth information of the real objects within the working area. Server 106 generates the integrated depth map D by taking a union of depth map D₁ and all transformed depth maps ¹D₂ and ¹D₃:

D=D₁∪¹D₂∪¹D₃.

Server 106 stores integrated depth map D in, for example, computer-readable medium 108 for later retrieval and reference.

At step 310, server 106 receives position parameters from user devices 118A-118C as described above.

At step 312, based on the integrated depth map D and the position parameters from user devices 118A-118C, server 106 determines depth information corresponding to the point of view of each individual one of users 120A-120C. Specifically, server 106 first transforms the position parameters of a user device from a world coordinate system to the common coordinate system associated with camera 1 (i.e., camera 102A). This is achieved by, for example, multiplying the position parameters of the user device with a transformation matrix that represents the transformation from the world coordinate system to the common coordinate system. The world coordinate system is associated with, for example, the working area. The transformation matrix from the world coordinate system to the common coordinate system may be determined when camera 102A is installed or during system initialization.

Server 106 determines the depth information corresponding to the point of view of each individual user by referring to the integrated depth map. The depth information indicates occlusions, when viewed from the point of view of the individual user, between the real objects within the working area and the virtual objects generated and positioned by a computer into the additional images of the working area. Since the integrated depth map is a three-dimensional representation of the relative spatial relationships among the real objects, server 106 refers to the integrated depth map to determine an occlusion relationship among the virtual objects and real objects within the AR scene, that is, whether a particular virtual object should occlude or be occluded by a real object or another virtual object when viewed by the individual user.

At step 314, images of the AR scene are rendered and displayed to users 120A-120C based on the depth information corresponding to their respective points of view. The rendering of the images may be performed on server 106. For example, server 106 receives additional images of the working area from each individual user device. Based on the depth information corresponding to the individual user device, server 106 modifies the additional images of the working area provided by the user device and inserts images of the virtual objects therein to form images of the AR scene.

Since the depth information corresponding to the point of view of each individual user provides a basis for determining mutual occlusions between the real and virtual objects within the AR scene, the modified images provide a realistic representation of the AR scene including the real and virtual objects. Server 106 then transmits the resulting images back to corresponding user devices 118A-118C for display to the users.

Alternatively, the rendering of the images of the AR scene may be performed on individual user devices 118A-118C. For example, server 106 transmits the depth information to the corresponding user device. On the other hand, each of user devices 118A-118C captures additional images of the working area according to the point of view of its user. Based on the received depth information, user devices 118A-118C determine proper occlusions between the real and virtual objects corresponding to their respective points of view and modify the additional images of the working area to include the images of the virtual objects based on depth information. User devices 118A-118C then display the resulting images to the respective users, so that users 120A-120C each have a perception of the AR scene consistent with their respective point of view.

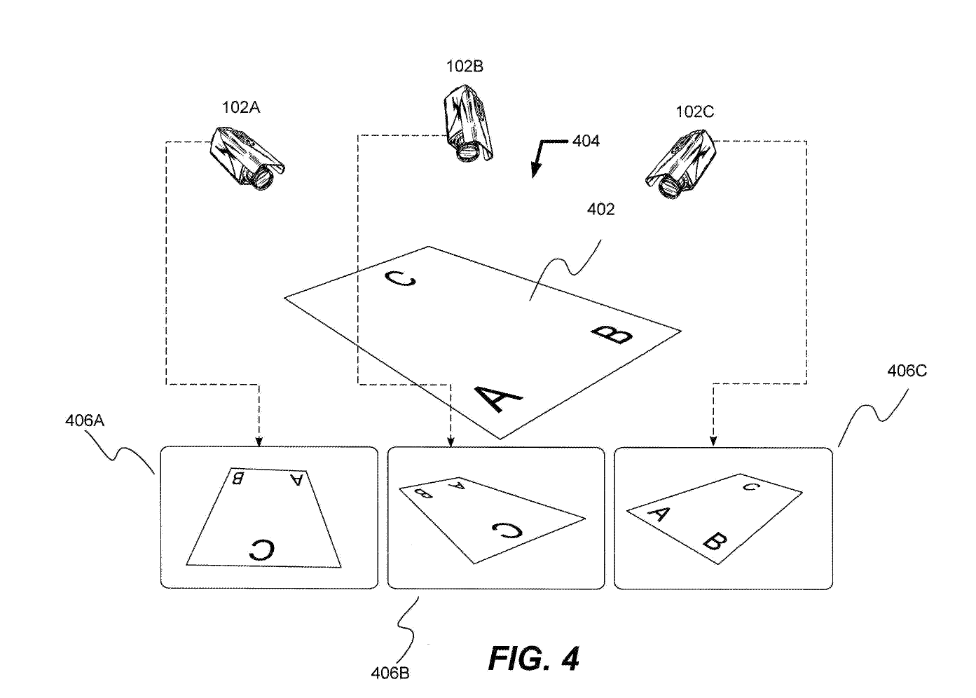

FIGS. 4-6D depict a calibration process for determining transformation matrix ^{j}Ωᵢ from a coordinate system associated with one camera to a coordinate system associated with another camera. As shown in FIG. 4, during the calibration process, a calibration object 402 having a predetermined image pattern is presented in a working area 404. The predetermined image pattern of calibration object 402 includes at least three non-collinear feature points that are viewable and identifiable through cameras 102A-102C. The non-collinear feature points are denoted as, for example, points A, B, and C shown in FIG. 4. Cameras 102A-102C capture images 406A-406C, respectively, of calibration object 402.

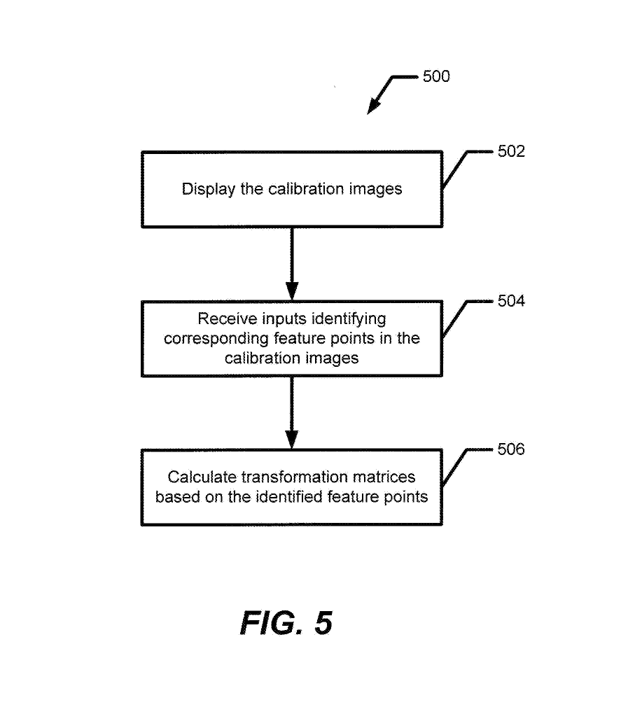

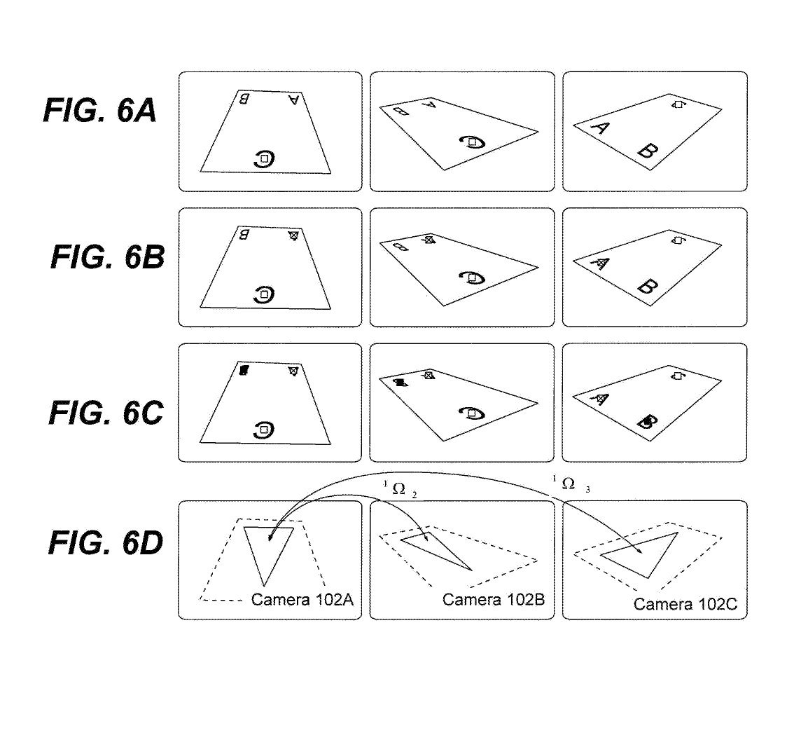

Based on images 406A-406C shown in FIG. 4, server 106 performs a calibration process 500, depicted in FIG. 5. According to process 500, at step 502, server 106 displays the images 406A-406C on display device 112. In step 504, server 106 receives inputs from, for example, an operator viewing the images on display device 112. The inputs identify the corresponding feature points A, B, and C in images 406A-406C, as shown in FIGS. 6A-6C. At step 506, server 106 calculates the transformation matrices based on the identified feature points A, B, and C. For example, server 106 selects a coordinate system associated with camera 102A as a reference system and then determines the transformations of the feature points A, B, and C from coordinate systems associated with cameras 102B and 102C to the reference system by solving a linear equation system. These transformations are represented by transformation matrices ¹Ω₂ and ¹Ω₃, shown in FIG. 6D.

Alternatively, server 106 may identify feature points A, B, and C on the images of calibration object 402, automatically, using pattern recognition or other image processing techniques and determine the transformation matrices (e.g., ¹Ω₂ and ¹Ω₃) among the cameras with minimal human assistance.

Other embodiments of the invention will be apparent to those skilled in the art from consideration of the specification and practice of the embodiments disclosed herein. For example, the number of cameras used to determine the depth maps of the working area may be any number greater than one. In addition, the images of the AR scene generated based on the depth information may be used to form a video stream by the server or the user device described herein.

The scope of the invention is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

What is claimed is:

1. A method for determining individualized depth information in an augmented reality scene, comprising:
receiving a plurality of images of a physical area from a plurality of cameras;
extracting a plurality of depth maps from the plurality of images;
generating an integrated depth map from the plurality of depth maps; and
determining individualized depth information corresponding to a point of view of a user based on the integrated depth map and a plurality of position parameters.

2. The method of claim 1, further comprising:
receiving the position parameters from a user device, the position parameters indicative of the point of view of the user associated with the user device within the physical area.

3. The method of claim 1, further comprising:
generating an image of an augmented reality scene based on the individualized depth information, the augmented reality scene including a combination of the physical area and a computer-generated virtual object, the image representing a view of the augmented reality scene consistent with the point of view of the user.

4. The method of claim 3, further comprising:
detecting a change in the point of view of the user; and
updating the image of the augmented reality, in real time, in response to the change in the point of view.

5. The method of claim 3, further comprising:
receiving an additional image of the physical area;
generating the image of the augmented reality based additionally on the additional image of the physical area.

6. The method of claim 5, further comprising:
receiving the additional image of the physical area from the user device.

7. The method of claim 5, wherein the additional image of the physical area includes at least one image of a physical object disposed within the physical area, and the individualized depth information indicates a relative position of the physical object within the physical area.

8. The method of claim 7, wherein the generating of the image of the augmented reality scene comprises:
generating a virtual object;
determining an occlusion relationship between the virtual object and the physical object based on the individualized depth information; and
forming the image of the augmented reality scene by combining the image of the virtual object with the additional image of the physical area according to the occlusion relationship.

9. The method of claim 1, wherein each depth map is defined in a coordinate system associated with one of the cameras, the generating of the integrated depth map further comprising:
selecting the coordinate system associated with one of the cameras as a common coordinate system;
transforming the depth maps defined in other coordinate systems associated with other ones of the cameras to the common coordinate system; and
combining the transformed depth maps and the depth map defined in the common coordinate system.

10. The method of claim 9, further comprising:
transforming the position parameters of the user device to the common coordinate system.

11. The method of claim 9, further comprising:
receiving, from the cameras, a plurality of images of a calibration object including a plurality of feature points;
identifying the feature points in the images of the calibration object;
determining at least one transformation matrix indicative of a coordinate transformation from the other coordinate systems to the common coordinate system; and
transforming the depth maps defined in the other coordinate systems based on the transformation matrix.

12. The method of claim 1, wherein the images of the physical area from the cameras correspond to different points of view.

13. The method of claim 2, further comprising transmitting the individualized depth information to the user device.

14. A non-transitory computer-readable medium comprising instructions, which, when executed by a processor, causes the processor to perform a method for determining individualized depth information in an augmented reality scene, the method comprising:
receiving a plurality of images of a physical area from a plurality of cameras;
extracting a plurality of depth maps from the plurality of images;
generating an integrated depth map from the plurality of depth maps; and
determining individualized depth information corresponding to a point of view of a user based on the integrated depth map and a plurality of position parameters.

15. The computer-readable medium of claim 14, the method further comprising:
receiving the position parameters from a user device, the position parameters indicative of a point of view of a user associated with the user device within the physical area.

16. The computer-readable medium of claim 14, the method further comprising:
generating an image of an augmented reality scene based on the individualized depth information, the augmented reality scene including a combination of the physical area and a computer-generated virtual object, the image representing a view of the augmented reality scene consistent with the point of the view of the user.

17. The computer-readable medium of claim 16, the method further comprising:
detecting a change in the point of view of the user; and
updating the image of the augmented reality, in real time, in response to the change in the point of view.

18. The computer-readable medium of claim 16, the method further comprising:
receiving an additional image of the physical area;
generating the image of the augmented reality scene based additionally on the additional image of the physical area.

19. The computer-readable medium of claim 18, the method further comprising:
receiving the additional image of the physical area from the user device.

20. The computer-readable medium of claim 18, wherein the additional image of the physical area includes at least one image of a physical object disposed within the physical area, and the individualized depth information indicates a relative position of the physical object within the physical area.

21. The computer-readable medium of claim 20, wherein the generating of the image of the augmented reality scene comprises:
generating a virtual object;
determining an occlusion relationship between the virtual object and the physical object based on the individualized depth information; and
forming the image of the augmented reality scene by combining the image of the virtual object with the additional image of the physical area according to the occlusion relationship.

22. A system for determining individualized depth information in an augmented reality scene, comprising:
a memory for storing instructions; and
a processor for executing the instructions to:
receive a plurality of images of a physical area from a plurality of cameras;
extract a plurality of depth maps from the plurality of images;
generate an integrated depth map from the plurality of depth maps;
receive position parameters from a user device, the position parameters indicative of a point of view of a user associated with the user device within the physical area; and
determine individualized depth information corresponding to the point of view of the user based on the integrated depth map and the position parameters.
